(19) United States
(12) Patent Application Publication
(10) Pub. No.: US 2006/0096997 A1
(43) Pub. Date: May 11, 2006

(54) Managing system for vending machine

(76) Inventor: Tae-Soon Yeo, Kyunggi-do (KR)

Correspondence Address: YOUNG & THOMPSON, 745 SOUTH 23RD STREET, 2ND FLOOR, ARLINGTON, VA, 22202, US

(21) Appl. No.: 10/514,479

(22) PCT Filed: May 16, 2003
(86) PCT No.: PCT/KR03/00973

§ 371 Date: Dec. 19, 2005

(30) Foreign Application Priority Data
May 16, 2002 (KR) 10 2002 0027085

(51) Int. Cl. G07F 11/00

(52) U.S. Cl. 221/9

(57) ABSTRACT

A system for managing a plurality of vending machines from a main vending machine using a management network, without the need to periodically visit and check all the machines, and effectively managing a plurality of vending machines even from a remote place using a wire or wireless Internet system. The main vending machine includes a controller for controlling a vending machine mechanism and processing data transmitted from each sub-vending machine to store it in a memory: a Bluetooth communication module for transmitting various data from each sub-vending machine to the controller; a display for displaying sales and management information of each sub-vending machine, s a moving picture outputted by a graphic controller according to a signal outputted from the controller; and a keypad for controlling the controller and the display and selecting items.

### TECHNICAL FIELD

The present invention relates to a system for managing a plurality of vending machines placed within a predetermined distance using a management network through the management of only one of those vending machines, without the need to periodically visit and check all the machines, and managing a plurality of vending machines even from a remote place using a wire or wireless Internet system.

### BACKGROUND ART

As generally known, vending machines are installed in office buildings, convenience stores and streets to automatically sell and dispense soft drinks, coffee, etc., to customers without salesclerks. In other words, when a customer puts coins or a bill into a cash (coin or bill) acceptor of a vending machine which is stocked with items such as coffee or soft drinks, and presses an item selection button, the vending machine automatically dispenses the selected item and the change, if any.

Vending machines can sell more than one item. Although vending machines eliminate the need for a human salesclerk, servicers are required to restock the machines with products periodically. Since one servicer generally manages more than one vending machine, he or she should visit and check the vending machines every day, carrying products using a vehicle to restock the machines. Vending machine servicers restock the machines with products, collect money and refill coins as change. They also keep the machines clean and sometimes repair the machines for proper operation.

The servicers have no way of knowing the exact sales amount of each item before restocking the vending machines. If more than one item is sold, the servicers should carry various items of products in large amounts whenever visiting the vending machines.

Also, the servicers cannot know immediately when a problem occurs in operation of a vending machine. They become aware of the problem only when visiting and checking the problematic machine. This will reduce the sales of products, because customers cannot use the machine until it is repaired.

Since the servicers should periodically visit and check a plurality of vending machines, considerable personnel expenses are incurred.

### DISCLOSURE OF THE INVENTION

Accordingly, the present invention has been made to solve the above-mentioned problems occurring in the prior art, and an object of the present invention is to provide a system for managing a plurality of vending machines, which enables a servicer to easily know the stock levels and the sales amount of each item in each vending machine, without the need to periodically visit and check the machines, and which enables easy management of the vending machines in real time even from a remote place using a wire or wireless Internet system.

Another object of the present invention is to provide a system for managing vending machines, which enables a customer to call a servicer using a Bluetooth communication module installed on each vending machine, without using a separate communication means, when a vending machine does not properly operate.

In order to accomplish the above-mentioned objects, there is provided a main vending machine and a plurality of sub-vending machines, said main vending machine comprising: a controller for controlling a vending machine mechanism and processing data transmitted from each sub-vending machine to store it in a memory; a Bluetooth communication module for transmitting various data from each sub-vending machine to the controller through a data signal processing section; a sensor for sensing items on sale and sending data concerning the items to the controller; a display means for displaying sales and management information of each sub-vending machine, as well as a moving picture outputted by a graphic controller according to a signal outputted from the controller; and a keypad for controlling the controller and the display means and selecting items. Each sub-vending machine comprises: a Bluetooth communication module for communicating with that installed on the main vending machine; a controller for receiving and transmitting various data from and to the Bluetooth communication module through a data processing section and controlling a vending machine mechanism; and a sensor for transmitting data concerning items on sale to the controller.

### BRIEF DESCRIPTION OF THE DRAWINGS

The above and other objects, features and advantages of the present invention will be more apparent from the following detailed description taken in conjunction with the accompanying drawings, in which:

FIG. 1 is a schematic view of a system for managing vending machines according to the present invention.

FIG. 2 is a schematic view showing the front side of a vending machine of FIG. 1.

FIG. 3 is a block diagram showing the detailed construction of a main vending machine of FIG. 1.

FIG. 4 is a block diagram showing the detailed construction of a sub-vending machine of FIG. 1.

FIG. 5 is a flow chart showing a process of stocking and selling products in a vending machine according to the present invention.

FIG. 6 is a flow chart showing a process of lending and retrieving a product in a vending machine according to the present invention.

FIG. 7 is a flow chart showing a process of displaying an advertisement of a product according to the present invention.

FIG. 8a is a flow chart showing a process of managing vending machines from a remote place according to the present invention.

FIG. 8b is a flow chart showing a process of managing vending machines using a management PDA according to the present invention.

FIG. 9 is a flow chart showing a process of calling a vending machine servicer according to the present invention.

### BEST MODE FOR CARRYING OUT THE INVENTION

Hereinafter, preferred embodiments of the present invention will be described with reference to the accompanying drawings. In the following description and drawings, the same reference numerals are used to designate the same or similar components, and so repetition of the description on the same or similar components will be omitted.

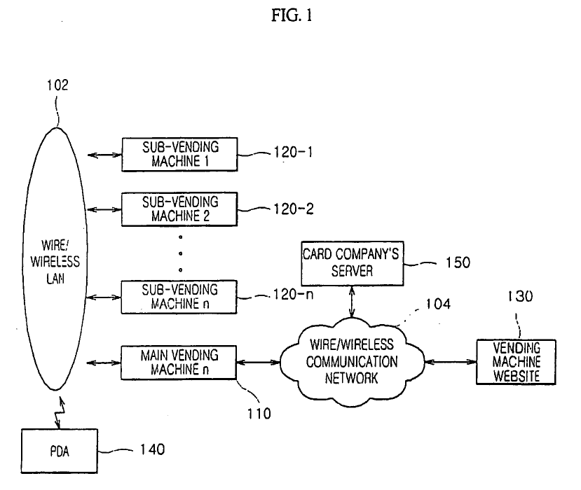

FIG. 1 is a schematic view of a system for managing vending machines according to the present invention. When a plurality of vending machines are installed in one building, any one installed at a location easily accessible by a servicer, for example, the machine at the first floor, can be designated as a main vending machine 110 (hereinafter “main machine”). The other machines in the same building can be sub-vending machines 120-1 to 120-n (hereinafter “sub-machines”). The main machine 110 is connected to each of the sub-machines 120-1 to 120-n by a wire or wireless LAN 102.

The main machine 110 is also connected through a wire or wireless communication network to a card company's server 150 for processing payment by credit card and to a vending machine-management server website 130 for manacling the vending machines according to the present invention. A PDA 140 handheld by a servicer is used to communicate with the main machine 110 or the sub-machines 120-1 to 120-n through Bluetooth.

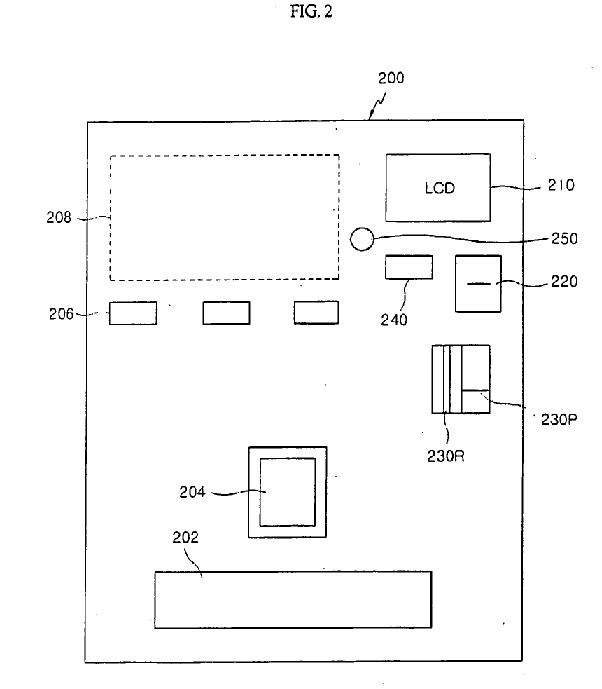

As shown in FIG. 2, the main machine 110 or each of the sub-machines 120-1 to 120-n comprises a display section 210, such as a LCD display, for advertising a product: an item display window 208 for showing a sample of each item on sale: a button 205 for showing a price of each item and selecting a desired item to buy: a keypad 240: a digital camera 250; a change dispenser 204; an item dispenser 202: a cash acceptor 220 for accepting a coin or a bill; and a card reader 230R and a printer 230P for processing payment by credit card.

The card reader 230R installed on the main machine 110 is connected to the card company's server 150 for wire or wireless communication through a communication network 104 in order to request and receive an approval for payment by credit card. The card reader 230R installed on each of the sub-machines 120-1 to 120-n communicates with the main machine 110 through Bluetooth to receive an approval for payment by credit card. The card reader 230R is a credit card checker including the built-in printer 230P (thermal, dot, ink-jet or the like) for printing a credit card receipt. The card reader 230R of the main machine 110 includes a wire or wireless communication means (e.g., a wire or wireless Internet system) for communication with the card company's server 150.

Customers can communicate with the servicer's handheld PDA 140 through the wire or wireless communication means or Bluetooth. Also, the servicer can know the stock levels or sales amount in the main machine or the sub-machines.

It is possible to use a portable payment device which is disclosed in Korean Patent Application No. 2002-23509 entitled “Payment System”, without installing the card reader 230R on each vending machine. The “portable payment device” is a contactless payment device which can access a card company's server for payment through a Bluetooth communication module.

As shown in FIG. 2, the main machine or each sub-machine comprises the display section 210, such as a LCD display, for moving picture or still picture advertisement of a product, the keypad 240 (or a touch screen) and the button 206 for selecting a desired item. Also, the digital camera 250 is provided to take a still or moving picture of the machine itself or take a photo of a customer for security purpose.

The card reader 230R is protruded outwardly from the front surface of the vending machine so that a customer can easily use it to buy an expensive article, such as a DVD disc, without cash. The sensor provided on the main and sub-machines senses items sold and released out, and checks the sales amount of each item. Each vending machine is generally stocked with various items (soft drinks, DVD discs, etc.). If a sensor, such as a photocoupler, is installed in each passage dropping down an item into the item dispenser, it will be possible to easily know the items on sale and the sales amount of each item.

Although not shown in the drawings, an encryption module is provided to encipher all data, which is transmitted or received through the Bluetooth module, or which is transmitted through the wire or wireless communication module, thereby preventing wiretapping or hacking during transmission of important payment data.

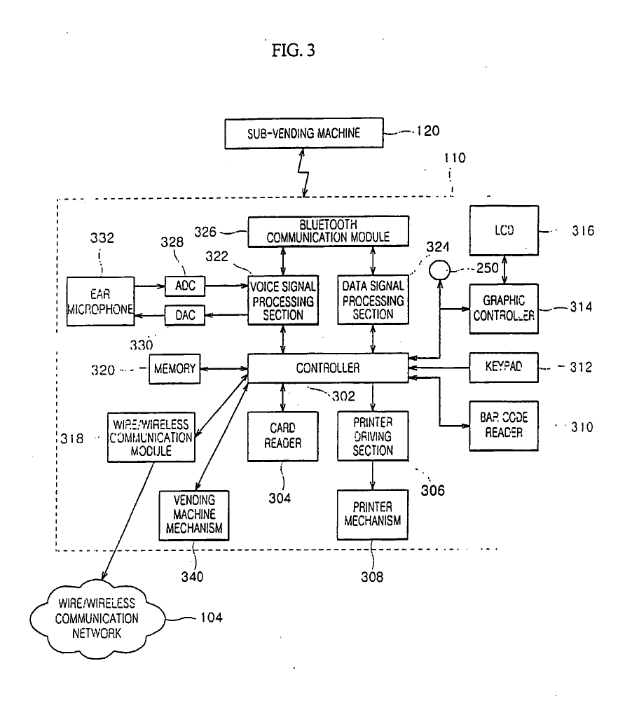

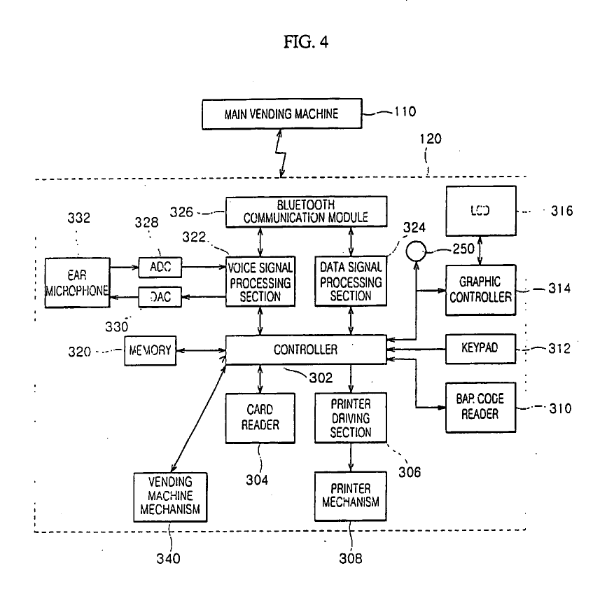

FIG. 3 is a block diagram showing the detailed construction of the main vending machine of FIG. 1. FIG. 4 is a block diagram showing the detailed construction of the sub-vending machine of FIG. 1.

Referring to FIG. 3, the main machine 110 comprises a Bluetooth communication module 326 for data communication and voice communication with sub-vending machines 120-1 to 120-n; a data signal processing section 324 for processing data received from and transmitted to the sub-vending machines 120-1 to 120-n through the Bluetooth communication module 326; a voice signal processing section 322 for processing voice data; a controller 302 for controlling each part of the main machine 110 and processing data transmitted from each of the sub-vending machines 120-1 to 120-n: a card reader 304 for reading information about a credit card: a memory 320 having a driving program for each part of the main machine and storing credit card information read through the card reader 304, when a credit card is used with the main machine or any of the sub-machines, as well as sales information transmitted from the main machine and each sub-machine; a print mechanism 308 for printing a credit card receipt; a printer driving section 306 for driving the print mechanism 308; a wire or wireless communication module 318 for accessing a card company's server 150 through a communication network 104 and communicating with a wireless communication terminal, such as a servicer's handheld PDA 140; and a keypad 312 provided with a plurality of function buttons and number buttons for selecting an item and checking the validity of a credit card and various data transmitted from each sub-machine. The main machine 110 also comprises a digital camera 250 for taking photos of the main machine itself and customers for security purpose.

Further, the main machine 110 is provided with an analog to digital converter (ADC) 328 for converting an analog voice signal inputted from an ear microphone 332 during voice communication into a digital voice signal and outputting the converted signal to the voice signal processing section 322: and a digital to analog converter (DAC) 330 for converting a digital voice signal received through the Bluetooth communication module 326 and processed at the voice signal processing section 322 into an analog voice signal and outputting the converted signal to the ear microphone 332.

The controller 302 is connected to a graphic controller 314 for projecting and displaying a moving picture or the like on a LCD display 316. The controller 302 is also connected to a bar code reader 310 for verifying a bar code labeled on each item.

Referring to FIG. 4, each of the sub-machines 120-1 to 120-n comprises: a digital camera 250, a Bluetooth communication module 326 for data communication and voice communication with the main machine 110; a data signal processing section 324 for processing data received from and transmitted to the main machine 110 through the Bluetooth communication module 326; a voice signal processing section 322 for processing voice data received from and transmitted to the main machine 110; a controller 302 for controlling each part of each sub-machine 120-1 to 120-n; a card reader 304 for reading information about a credit card; a memory 320 having a driving program for each part of the sub-machine and temporarily storing credit card information read through the card reader 304 when checking a credit card; a print mechanism 308 for printing a credit card receipt; a printer driving section 306 for driving the print mechanism 308 under the control of the controller 308; and a keypad 312 provided with a plurality of function buttons and number buttons for selecting an item and checking the validity of a credit card and controlling a display means.

Further, each sub-machine is provided with an analog to digital converter (ADC) 328 for converting an analog voice signal inputted from an ear microphone 332 during voice communication into a digital voice signal and outputting the converted signal to the voice signal processing section 322; and a digital to analog converter (DAC) 330 for converting a digital voice signal received through the Bluetooth communication module 326 and processed at the voice signal processing section 322 into an analog voice signal and outputting the converted signal to the ear microphone 332.

The controller 302 is connected to a graphic controller 314 for projecting and displaying a moving picture or the like on a LCD display 316. The controller 302 is also connected to a bar code reader 310 for verifying a bar code labeled on each item.

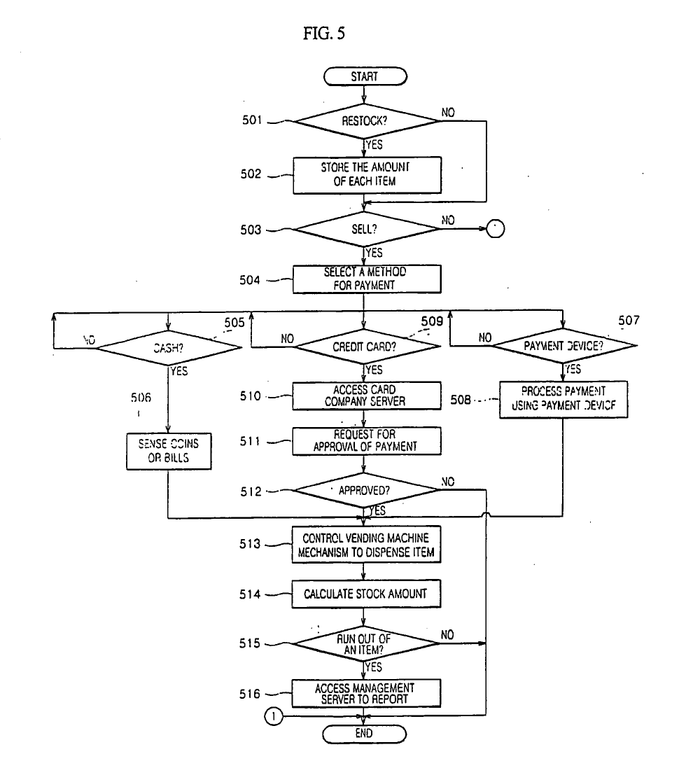

FIG. 5 is a flow chart showing a process of stocking and selling products in a vending machine according to the present invention.

A plurality of vending machines installed in every floor of a building are stocked with items to be sold (S501), and information about the amount of each item is stored (S502).

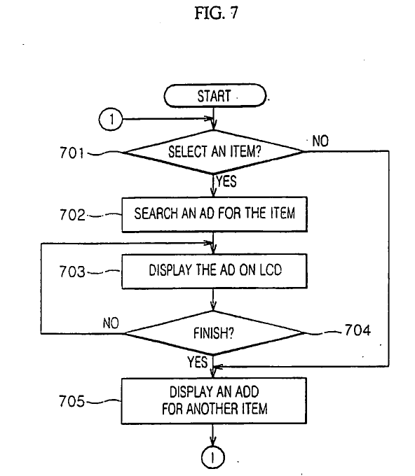

Customers can buy items, such as soft drinks, coffee or DVD discs, from a vending machine. As shown in FIG. 7, the LCD display 316 of the sub-machines 120-1 to 120-n and the main machine 110 shows a moving picture which advertises the items on sale to increase the customers' desire to buy them. When the vending machines operate, the controller 302 controls the graphic controller 314 based on the information, which has been previously inputted from the keypad 314, to continuously feature a moving picture advertisement on the LCD display 316 (S701 to S705).

If a customer selects an item using the button 206 or the keypad 240, the vending machine will demand payment (S503, S504). The customer can directly pay for the item by inserting cash (coins or a bill) into the cash acceptor. Alternatively, the customer can use the card reader 230R installed on the front side of the vending machine or a portable payment device for wireless payment. The portable payment device comprises a Bluetooth communication module, a data signal processing section, a password processing section, a key input section, a payment and deposit button, a rechargeable chip, a wire or wireless communication module, a controller and an LCD. The portable payment device can communicate with the vending machine through the Bluetooth communication module for wireless transfer of data in the rechargeable chip or authentication information (information required to use a credit card).

It a customer inserts coins or a bill into the cash acceptor 220 to pay for the selected item, a sensor fixed to the cash acceptor 220 will sense the inserted coins or bill. If an amount greater than the price of the selected item is inserted, a vending machine mechanism 340 will be controlled to dispense an appropriate amount of change, together with the selected item itself (S505, S506, S513).

If a customer uses the portable payment device as mentioned above, the vending machine will transfer the amount to be paid and request for payment. The customer will confirm the amount and will pay by deducting the amount from the rechargeable chip or will pay by credit card by providing authentication information (information required to use a credit card). If the customer pays by credit card using the portable payment device, the general flow of processing the payment will be the same as the flow when using the card reader.

If a customer uses the card reader 230R to pay for a selected item, the card reader 230R will communicate with the main machine 110 through Bluetooth network and will access the card company's server 150 through the wire or wireless communication network 104 to request an approval for payment by credit card. If the card reader 230R receives the approval, the vending machine mechanism 340 will be controlled to dispense the selected item, (S509 to S513).

The amounts of items stocked are compared with the amounts of items dispensed out to determine whether a vending machine should be restocked. When a vending machine runs out of a particular item, it accesses the vending machine management server website 130 through the wire or wireless communication network and informs the out-of-stock item (S514 to S516).

For example, if soft drinks or DVD discs are sold from the sub-machines 120-1 to 120-n, the sensor 310 will sense and scan each of the sold items and will send a recognized signal to the controller 302. The controller 302 will then send the signal to the main machine 110 through the data signal processing section 324 and the Bluetooth communication module 326.

Various data (items on sale, stock levels, etc.) transmitted to the main machine 110 from the sub-machines 120-1 to 120-n are stored in the memory 320 under the control of the controller 302.

When a servicer visits the main machine 110, he or she can see the sales amount and stock level of each item in the main machine 110 and the sub-machines 120-1 to 120-n, which are stored in the memory 320 by the controller 302, by operating the keypad 312 to display such data on the LCD display 316. In other words, the memory 320 of the main machine 110 stores all information about the sub-machines 120-1 to 120-n. The servicer can see the information through the LCD display 316 of the main machine 110.

When information (for example, management information) is displayed on the LCD display 316, the servicer can monitor the sales and stock levels in each of the sub-machines 120-1 to 120-n at a glance and make sure the sub-machines 120-1 to 120-n operate properly.

From the management information displayed on the LCD display 316, the servicer determines which sub-machines 120-1 to 120-n should be restocked and which items are required in each machine. The servicer can visit the machines carrying only the required items.

The sub-machines 120-1 to 120-n are identified by their unique identification numbers. The controller 302 of the main machine 110 uses the identification numbers when storing information about the sub-machines in the memory 320.

According to the present invention, the servicer can easily manage a plurality of sub-machines by visiting only a sub-machine requiring restocking, bringing only the item or items required in the sub-machine. In addition, the servicer can easily get information about the sub-machines 120-1 to 120-n, even without visiting all the machines. This greatly reduces the time required to manage a plurality of vending machines.

Also, if the stock level of an item in the main machine or any sub-machine is lower than a predetermined level (if an item at a low stock level cannot be dispensed or detected by the sensor over a certain period of time), the controller 302 of the main machine or the sub-machine will promptly send the information stored in the memory 320 to the servicer, together with an urgency signal, so that the servicer can restock the machine with the required item as soon as possible. This will prevent a sales reduction caused when a vending machine completely runs out of an item.

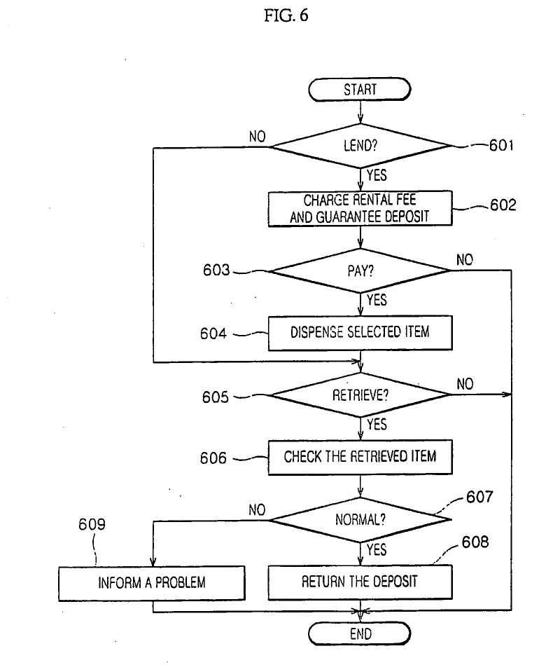

FIG. 6 is a flow chart showing a process of lending and retrieving an item in a vending machine according to the present invention.

Referring to FIG. 6, a vending machine can provide product (e.g., DVD discs) rental services through rental and retrieval processes.

In a rental process, a rental fee including a guarantee deposit is charged. When a customer pays the fee, the vending machine dispenses the selected item (S601 to S604). An appropriate amount of guarantee deposit is needed to provide for a case when the item is not retrieved. As described above, the customer can directly pa! the rental fee by inserting cash (coins or bills) into the cash acceptor or use the card reader 230R installed on the front side of the vending machine or a portable payment device for wireless payment.

In a retrieval process when the customer returns the borrowed item the vending machine confirms whether the item is normally retrieved. The vending machine returns the guarantee deposit to the customer in case of normal retrieval. If the item is not normally retrieved, the vending machine will inform the customer of the problem (S605 to S608). As will be described below the customer can call the servicer to settle the problem.

In order to buy expensive items, such as DVD discs from a vending machine, customers may swipe their credit cards through the card reader 304 installed on each of the sub-machines 120-1 to 120-n.

Information of a credit card, which has been read by the card reader 304 of a sub-machine, is transmitted to the main machine 110 through the data signal processing section 324 and the Bluetooth communication module 326. Subsequently, the information is transmitted to the card company's server 150 through the wire or wireless communication module 318 and the communication network 104 to request and receive an approval for payment by credit card.

When receiving the approval for payment by credit card, the card reader 304 sends a signal to the controller 302 of the sub-machine through the data signal processing section 324 and the Bluetooth communication module 326 and prints out a credit card receipt through the printer 308.

If a vending machine provides rental services for expensive items, such as DVD discs, it should additionally include a separate compartment for retrieving items and a bar code scanner for scanning retrieved items. In order to borrow an item the customer should input his or her personal information using the keypad 312 so that the vending machine can make inquiries about the customer (for example, check the customer's resident registration number) before lending the selected item.

If any of the sub-machines 120-1 to 120-n has a problem in operation, the controller 302 of the problematic sub-machine will output an error signal. The signal will be transmitted to the main machine 110 through the Bluetooth communication module 326 so that the wire or wireless communication module 318 of the main machine 110 can send the signal to the management server website 130 or to the servicer's PDA 140 or mobile phone through the Internet. Accordingly, it is possible to easily manage a plurality of sub-vending machines, by checking only one main vending machine.

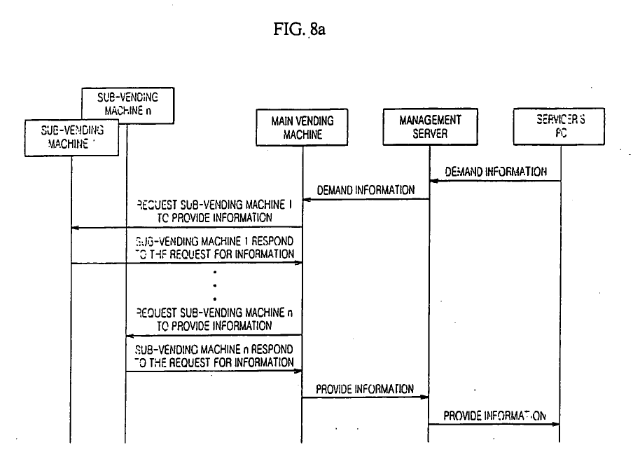

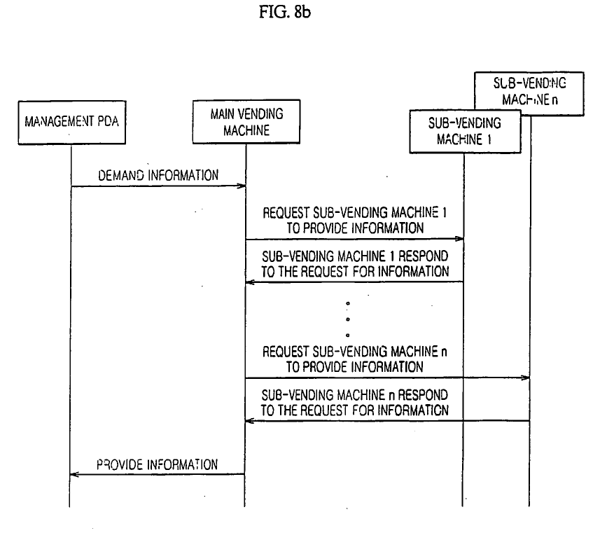

FIG. 8a is a flow chart showing a process of managing vending machines from a remote place according to the present invention.

Referring to FIG. 8a, if a servicer access the vending machine management server website 130 using a computer and demands information required to manage vending machines (for example, information about any error and stock level of each vending machine) the management server website 130 will access the main machine 110 through the communication network 104 to demand the same information.

The main machine 110 will then request the sub-machines 120-1 to 120-n, to which it is connected through the Bluetooth network 102, to provide the information. Accordingly, the sub-machines 120-1 to 120-n will provide information about any errors stock levels, sales amounts, etc., to the main machine 110.

The main machine 110 will integrate all information received from the sub-machines 120-1 to 120-n and will send the integrated information to the management server website 130 through the communication network 104. The management server website 130 will store the received information in its database and at the same time send the information to the servicer's computer.

Information about the sub-machines can be provided unperiodically upon the servicer's demand. Alternatively, the main machine 110 itself can periodically provide the information collected from the sub-machines 120-1 to 120-n to the vending machine management server website 130.

FIG. 8b is a flow chart showing a process of managing vending machines using a management PDA according to the present invention.

Referring to FIG. 8b, a servicer carrying a management PDA 140 can demand information about the sub-machines at a place near the main machine 110. If the main machine 110 stores up-to-date information about the sub-machines, it will promptly provide the information. If the main machine 110 stores out-of-date information or no information about the sub-machines, it will request the sub-machines 120-1 to 120-n to provide information about their current state. The main machine 110 will then provide the information collected from the sub-machines to the servicer's PDA 140. It is also possible to directly communicate with a particular sub-machine through the PDA 140 to check the state of the sub-machine.

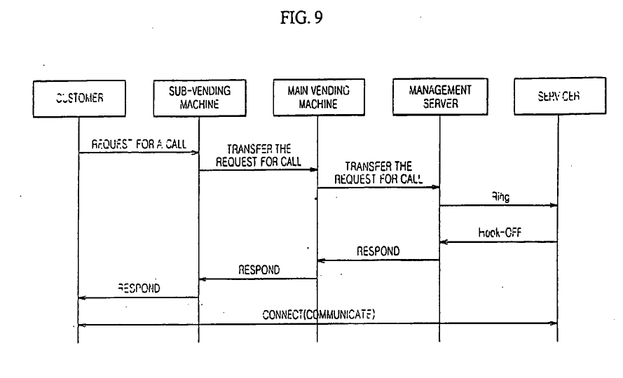

FIG. 9 is a flow chart showing a process of calling a vending machine servicer according to the present invention.

When a customer confronts an error in using a vending machine to buy an item or to return a borrowed item, he or she can call a servicer using an ear microphone 332 installed on each of the sub-machines 120-1 to 120-n. Then, the problematic sub-machine will access the main machine 110. The main machine 110 will transfer the customer's demand for a call to the vending machine management server website 130 through the communication network 104. Subsequently, the management server website 130 will call the servicer. After responding to the call, the servicer will transfer a response to the customer in an inverse sequence to speak with the customer.

As described above, the present invention connects a plurality of sub-vending machines to a main vending machine through a Bluetooth communication module to enable a servicer to get various information about the sub-vending machines from the main vending machine. According to the present invention, it is possible to send information about the sub-vending machines to the servicer or the management server through the wireless Internet, thereby reducing the time, cost and effort to manage a plurality of vending machines.

Although preferred embodiments of the present invention has been described for illustrative purposes, those skilled in the art will appreciate that various modifications, additions and substitutions are possible, without departing from the scope and spirit of the invention as disclosed in the accompanying claims.

### INDUSTRIAL APPLICABILITY

The present invention is applicable to the manufacture of vending machines, which sell soft drinks, cup noodles or other products, and to a system for automatic rental services for DVD discs or CDs. Particularly, the present invention enables a servicer to effectively manage a plurality of vending machines from a main vending machine through a Bluetooth communication module. Also, the servicer can effectively manage a plurality of vending machines even from a remote place using a wire or wireless Internet system.

1. A system for managing vending machines in real time even from a remote place, wherein a main vending machine and a plurality of sub-vending machines are connected via a local area network (LAN) and said main vending machine can access a vending machine management server website through a wire or wireless communication network, wherein
said main vending machine comprises:
a vending machine mechanism composed of mechanical devices for containing items and dispensing a selected item according to a control signal;
a first input means;
a local area communication means for communicating with said sub-vending machines via LAN; and
a controller for requesting payment is an item is selected through said first input means, controlling said vending machine mechanism to dispense the selected item if payment is made according to a predetermined process, storing information received from said sub-vending machines through said local area communication means in a memory, and transmitting information about each sub-vending machine to said vending machine management server website through said wire or wireless communication network according to a predetermined process, and
each of said sub-vending machines comprises:
a vending machine mechanism composed of mechanical devices for containing items and dispensing a selected item according to a control signal;
a second input means;
a local area communication means for communicating with said main vending machine via LAN; and
a controller for requesting payment if an item is selected through said second input means, controlling said vending machine mechanism to dispense the selected item if payment is made according to a predetermined process, and transmitting information about the state of the sub-vending machine to said main vending machine through said local area communication means.

2. The system according to claim 1, wherein said main vending machine and said sub-vending machines further comprise:
a cash sensing means for sensing a coin or bill; and
a card reader connected to said controller to process payment by credit card, wherein:
when ‘cash’ is selected through each of said input means, said controller senses the amount of inserted cash through said cash sensing means to process payment: when ‘credit card’ is selected, said controller transmits credit card information inputted from said card reader to a card company's server through said wire or wireless communication network to process payment; when ‘payment device’ is selected, said controller transmits the amount to be paid to said payment device through said local area communication means, and when a customer selects one of a rechargeable chip or credit card using said payment device, said controller processes payment according to a corresponding process.

3. The system according to claim 1, wherein said local area communication network is a Bluetooth communication network.

4. The system according to claim 1, wherein said main vending machine and said sub-vending machines further comprise a display means for displaying various characters and pictures to advertise a product.

5. The system according to claim 1, wherein said main vending machine and said sub-vending machines further comprise a digital camera for taking photos of each vending machine itself and customers and sending a still or moving picture of each vending machine to said vending machine management server website for security purpose and for image communication with customers.

6. The system according to claim 1, wherein said main vending machine and said sub-vending machines further comprise a sensor for sensing retrieved items.

7. The system according to claim 1, wherein said main vending machine and said sub-vending machines further comprise an ear microphone for communication with a servicer and a voice signal processing section for processing a voice signal.

8. The system according to claim 1, further comprising a servicer's handheld terminal for monitoring the state of each vending machine in real time.

9. The system according to claim 2, wherein said local area communication network is a Bluetooth communication network.

10. The system according to claim 2, wherein said main vending machine and said sub-vending machines further comprise a display means for displaying various characters and pictures to advertise a product.

11. The system according to claim 2, wherein said main vending machine and said sub-vending machines further comprise a digital camera for taking photos of each vending machine itself and customers and sending a still or moving picture of each vending machine to said vending machine management server website for security purpose and for image communication with customers.

12. The system according to claim 2, wherein said main vending machine and said sub-vending machines further comprise a sensor for sensing retrieved items.

13. The system according to claim 2, wherein said main vending machine and said sub-vending machines further comprise an ear microphone for communication with a servicer and a voice signal processing section for processing a voice signal.

14. The system according to claim 2, further comprising a servicer's handheld terminal for monitoring the state of each vending machine in real time.
